(19) United States
(12) Patent Application Publication
(10) Pub. No.: US 2005/0275703 A1
(43) Pub. Date: Dec. 15, 2005

(54) Tool, method for drying recording sheet using the same and package with tool

(75) Inventors: Kenichi Yamaguchi, Urayasu-shi (JP); Hitoshi Nagashima, Chigasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/145,937

(22) Filed: Jun. 7, 2005

(30) Foreign Application Priority Data
Jun. 9, 2004 (JP) 2004-171239(PAT.)
Jun. 9, 2004 (JP) 2004-171241(PAT.)
Jun. 9, 2004 (JP) 2004-171242(PAT.)
Jun. 9, 2004 (JP) 2004-171243(PAT.)

(51) Int. Cl. B41J 2/01

(52) U.S. Cl. 347/102

(57) ABSTRACT

Disclosed herein is a tool having an opening capable of holding a recording sheet by being raised in a gable form, which comprises a hook capable of retaining the gable form utilizing a restoring-force when formed in the gable form, and a hook hole into which the hook can fit. The tool is used to stand the recording sheets subjected to recording in the opening raised in the gable form, thereby drying the recording sheet.

### BACKGROUND OF THE INVENTION

1. Field of the Invention

The present invention relates to a tool for holding a recording sheet, and particularly to a tool suitable for use in drying of a recording sheet on which printing has been conducted with an aqueous ink.

2. Description of the Background Art

In recent years, various recording media have been sold as ink-jet recording media for ink-jet recording. Although ink-jet recording apparatus conduct ink-jet recording on such recording media, recording media suitable for the fixing property of an ink itself used are often limited. Therefore, Japanese Patent Application Laid-Open No. S63-239073 discloses an apparatus that a next recording medium continuously subjected to recording is temporally held in a space above a recording medium previously subjected to recording and is stacked after fixing of an ink on the recording medium previously subjected to the recording is completed. This apparatus is complicated in the construction for satisfying this function and incurs the necessity of enlarging the apparatus.

On the other hand, since postal cards for ink-jet, which come to be used in JAPAN POST, are not optimized for ink properties of the ink-jet recording apparatus, under the circumstances, inks in an undried state on postal cards printed by an ink-jet recording method are dried by arranging the postal cards one by one on a desk or the like in order to dry the inks in the undried state. As a method for simply drying such a postal card, Japanese Patent Application Laid-Open No. 2003-276777 discloses a method in which a sheet member provided with comb-like supporting pieces formed in at least 2 rows by making a great number of cuts in substantially the same direction is used to stand ink-jet recording sheets printed therein, thereby drying them. This method serves to dry a great number of printed products at the same time by hanging them over the 2 comb-like supporting pieces, and it is described that this drying does not require a very wide place.

### SUMMARY OF THE INVENTION

By the way, in the ink-jet recording, apparatus for conducting recording on both surfaces of a recording medium are marketed. However, an ink-jet recording sheet, on both surfaces of which printing has been made, offers a problem on fixing after recording though it varies according to properties of various recording media. An investigation by the present inventors revealed that when a method of conducting printing on one surface, drying the printed surface, turning up the ink-jet recording sheet, conducting printing on the remaining blank surface and then drying it or a method of conducting double-side printing and then leaving the sheet thus printed to stand on the surface of a desk to dry it is performed, a problem that the same print quality cannot be achieved on both surfaces arose though the ink-jet recording sheet used is an ink-jet recording sheet for double-side printing. According to a method of hanging a printed sheet by a washing hanger or the like to dry it, such problems that an image area of the ink-jet recording sheet, particularly, a central area thereof is scratched arose. When printed surfaces of recording sheets subjected to double-side ink-jet recording were put together before they are not sufficiently dried and left to stand, images on both sheets migrated to each other to bring about a white hazy state (hereinafter referred to as “white haze”), thereby deteriorating the image quality. The phenomenon that the images migrate to each other as described above was marked when ink-jet recording media having glossy surfaces and ink-jet recording sheets provided with an ink-receiving layer on a non-absorptive base material, which does not absorb water and the like, such as a PET film or resin-coated paper are stacked on each other. Incidentally, the white haze is considered to be attributable to the fact that a dried portion and an undried portion are produced within the ink-receiving layer, and so the images look turbid by refraction and scattering of light. It is inferred that since a shot-in ink quantity varies according to the place within the recording area, and the dried state of inks varies according to the place when the printed surfaces are put together and left to stand, white haze occurs, which is observed as unevenness of image density, to deteriorate the image quality.

Thus, the present inventors have verified the invention disclosed in Japanese-Patent Application Laid-Open No. 2003-276777 to lead to the finding of the following problems. More specifically, it takes heavy labor to raise the rising portions of the supporting pieces to become a comb form one by one to assemble them to a state that ink-jet recording sheets can be stood against them. In addition, it was difficult to raise the supporting pieces to become a comb form to the same angle. Further, it is also described that portions having a function of a stopper for preventing the supporting piece from returning to the original form are provided at both end portions. However, the supporting piece might become loose at its central portion due to the restoring force thereof in some cases, and so the stability of an ink-jet recording sheet stood against it might become poor according to the place in some cases. The upright stability of each rising portion of the supporting piece to become a comb form was also poor, and so it fell down while rubbing against the recording sheet to scratch the recorded surface of the ink-jet recording sheet stood. It was also necessary to carefully work in such a manner that an ink-jet recording sheet comes into no contact with each rising portion of the supporting piece to become a comb form when the ink-jet recording sheet is stood or taken out.

The sheet member to become the tool came to be separately packaged in a package, and so there was a possibility that the tool may be lost after use.

Accordingly, the present invention is to provide an invention, which can solve at least one problem of a first problem that it takes heavy labor to assemble to a state capable of being used as a tool, a second problem that difficulties are encountered upon raising all the supporting pieces to become a comb form to the same angle, a third problem that the supporting piece becomes loose at its central portion due to the restoring force thereof, a fourth problem that the stability of an ink-jet recording sheet stood against the tool might become poor, a fifth problem that the recorded surface of the ink-jet recording sheet stood is scratched due to rubbing of each rising portion of the supporting piece to become a comb form against the ink-jet recording sheet, a sixth problem that the ink-jet recording sheet easily comes into contact with the rising portion when the ink-jet recording sheet is stood or taken out, and a seventh problem that the tool has a possibility that it may be lost after use. The problems described above are common to drying of other recording sheets than the ink-jet recording sheets subjected to single-side or double-side recording.

It is thus an object of the present invention to provide a tool that can be simply assembled to a state that ink-jet recording sheets can be stood against it, and the ink-jet recording sheets can be simply and stably stood, and a method by which recording sheets can be simply and stably dried. Other objects of the present invention can be understood from the following description.

In a first aspect of the present invention, there is thus provided a tool which solves the first, second, third and fifth problems among the above-described problems having openings capable of holding recording sheets by being raised in a gable form, which comprises hooks capable of retaining the gable form utilizing restoring force when formed in the gable form, and hook holes into which the hooks can fit.

In a second aspect of the present invention, there is also provided a tool which solves the first, second, third and sixth problems among the above-described problems comprising a divided portion, in which openings into which recording sheets can be inserted can be formed by raising a part of a flat sheet in a gable form. The divided portion forms the gable form with 2 slant faces continuing through a mountain fold line to become an apex line. Each of the openings is formed by drawing an opening cut portion to become the opening in the flat sheet along border lines to become sides of the slant faces. The border lines each have a cut portion passing through the front and back surface of the flat sheet and separating the opening cut portion and portions surrounding it, which become the sides of the slant faces, in advance. And at least a portion of the sides of the slant faces, with which the recording sheet comes into contact, is obtained from the portions separated from the opening cut portion in advance by the cut portion.

In a third aspect of the present invention, there is further provided a tool which solves the first, second, third and sixth problems among the above-described problems comprising a divided portion in which openings into which recording sheets can be inserted and stood can be formed by raising a part of a flat sheet in a gable form, hooks provided at a foot portion of the divided portion and capable of retaining the gable form utilizing restoring force when the divided portion has been formed in the gable form, and hook holes, into which the hooks can fit, which are adapted to fix the positions of the hooks in the fitted state to retain the gable form.

The divided portion forms the gable form with 2 slant faces continuing through a mountain fold line to become an apex line, and a distance between sides of slant faces of the divided portion opposing through each of the openings increases from the foot portion of the gable form toward an apex thereof.

In a fourth aspect of the present invention, there is still further provided a method for drying recording sheets, which solves the fourth and fifth problems among the above-described problems, comprising assembling the tools described above so as to raise the openings, with which the tool is equipped, in the gable form and standing recording sheets subjected to printing into the openings, thereby drying the recording sheets subjected to printing.

In a fifth aspect of the present invention, there is yet still further provided a package with a tool for recording sheets, which solves the first, second, third and seventh problems among the above-described problems, comprising a box capable of containing recording sheets therein and a tool fixed to at least one external surface of the box for drying recorded articles obtained by conducting recording on the recording sheets.

The tool can have openings capable of holding the recording sheets by being raised in a gable form, and further comprises hooks capable of retaining the gable form utilizing restoring force when formed in the gable form and hook holes into which the respective hooks can fit.

Other contents of the present invention should be understood from the preferred embodiments described below.

The respective aspects of the present invention exhibit an effect to solve the problems described above. According to such aspects, there can be provided tools that can be simply assembled in a form capable of standing recording sheets and can stably stand the recording sheets, and a method by which recording sheets can be simply and stably dried.

### BRIEF DESCRIPTION OF THE DRAWINGS

FIG. 1 is a typical cross-sectional view illustrating a state that a hook has been inserted into a hook hole in a tool according to the present invention after assembly.

FIG. 2 is a perspective view illustrating the tool of FIG. 1 after assembly.

FIG. 3 is a plan view illustrating the tool of FIG. 1 before assembly.

FIG. 4 is a typical cross-sectional view illustrating a state that a hook has been inserted into a hook hole in a tool according to another embodiment of the present invention after assembly.

FIG. 5 is a perspective view illustrating the tool of FIG. 4 after assembly.

FIG. 6 is a plan view illustrating the tool of FIG. 4 before assembly.

FIG. 7 is a perspective view illustrating a tool according to a further embodiment of the present invention after assembly.

FIG. 8 is a plan view illustrating the tool of FIG. 7 before assembly.

FIG. 9 is a typical cross-sectional view illustrating a state that a hook has been inserted into a hook hole in a tool according to a still further embodiment of the present invention after assembly.

FIG. 10 is an enlarged view of a portion where a hook is inserted into an insertion hole upon three-dimensional assembly of the tool of FIG. 9

FIG. 11 is a cross-sectional view illustrating a tool according to a yet still further embodiment of the present invention after assembly.

FIG. 12 is a perspective view illustrating the tool in FIG. 11 after assembly.

FIG. 13 is a plan view illustrating the tool of FIG. 11 before assembly.

FIG. 14 illustrates a state that recording sheets have been stood in a tool according to the present invention.

FIGS. 15A and 15B illustrate a case where cut marks of uncut portions may come into contact with a recording sheet, of which FIG. 15A illustrates a state before portions to become openings are cut off, and FIG. 15B illustrates a state after the portions to become openings are cut off.

FIGS. 16A and 16B illustrate a case where no uncut portion is provided to form openings, of which FIG. 16A illustrates a state before portions to become openings are cut off, and FIG. 16B illustrates a state after the portions to become openings are cut off.

FIGS. 17A and 17B illustrate a case where uncut portions are provided in dented portions, of which FIG. 17A illustrates a state before portions to become openings are cut off, and FIG. 17B illustrates a state after the portions to become openings are cut off.

FIGS. 18A, 18B and 18C illustrate a state that a division is automatically raised when a sheet member is opened, of which FIG. 18A illustrates a state that the division has been folded and contained in a state that the sheet member has been folded, FIG. 18B illustrates a state that the division has been raised by opening the sheet member, and FIG. 18C illustrates a state that openings, into which recording sheets can be inserted, have been formed.

FIGS. 19A and 19B are enlarged views illustrating state that the uncut portion in FIG. 17B has been provided in the dented portion, of which FIG. 19A illustrates a state that the angle of the dented portion is right, and FIG. 19B illustrates a state that the angle of the dented portion is round.

FIG. 20 is a perspective view illustrating a tool according to a yet still further embodiment of the present invention after assembly.

FIG. 21 is a plan view illustrating the tool of FIG. 20 before assembly.

FIG. 22 is a perspective view illustrating a tool according to a yet still further embodiment of the present invention after assembly.

FIG. 23 is a plan view illustrating the tool of FIG. 22 before assembly.

FIG. 24 is a perspective view illustrating another embodiment of the tool of FIG. 22 after assembly.

FIG. 25 is a plan view illustrating the tool of FIG. 24 before assembly.

FIG. 26 is an enlarged view of a portion where a hook is inserted into an insertion hole upon three- dimensional assembly of the tool of FIG. 24 according to the present invention.

FIG. 27 is a perspective view illustrating a tool according to a yet still further embodiment of the present invention after assembly.

FIG. 28 is a plan view illustrating the tool of FIG. 27 before assembly.

FIG. 29 illustrates the form of openings and a state that recording sheets have been stood.

FIG. 30 illustrates the form of openings and a state that recording sheets have been stood.

FIG. 31 illustrates the form of openings and a state that recording sheets have been stood.

FIGS. 32A, 32B, 32C and 32D are enlarged plan views illustrating the forms of openings in Tools 21 to 24 used in EXAMPLEs, of which FIG. 32A is an enlarged plan view of Tool 21, FIG. 32B is an enlarged plan view of Tool 22, FIG. 32C is an enlarged plan view of Tool 23, and FIG. 32D is an enlarged plan view of Tool 24.

FIG. 33 is a typical cross-sectional view illustrating a state that a hook has been inserted into a hook hole in a tool according to a yet still further embodiment of the present invention after assembly.

FIG. 34 is a perspective view illustrating the tool in FIG. 33 after assembly.

FIG. 35 is a development elevation of a package having the tool of FIG. 33.

FIG. 36 is a cross-sectional view of a package before a tool is assembled, or the package after the tool has been assembles and then returned to its original form.

FIG. 37 is a cross-sectional view of a package before a tool is assembled, or the package after the tool has been assembles and then returned to its original form.

FIG. 38 is a partial enlarged cross-sectional view illustrating the tool of FIG. 37 after assembly.

FIG. 39 is a development elevation of the package of FIG. 37 having the tool before assembly.

FIG. 40 is a perspective view illustrating a tool according to a yet still further embodiment after assembly.

FIG. 41 is a perspective view illustrating a tool according to a yet still further embodiment after assembly.

FIG. 42 is a cross-sectional view of a package before a tool is assembled, or the package after the tool has been assembles and then returned to its original form.

FIG. 43 is a cross-sectional view illustrating the tool after assembly in the package of FIG. 42.

FIG. 44 is a perspective view illustrating the tool after assembly in the package of FIG. 42.

FIG. 45 is a cross-sectional view of a package before a tool is assembled, or the package after the tool has been assembles and then returned to its original form.

FIG. 46 is a cross-sectional view illustrating the tool after assembly in the package of FIG. 45.

### DETAILED DESCRIPTION OF THE PREFERRED EMBODIMENTS

The present inventors have investigated, if the course of development of ink-jet recording sheets, a drying method thereof and found that ink-jet recording sheets can be simply dried by using a tool having openings capable of holding the recording sheets by being raised in a gable form, thus leading to completion of the invention related to the first to fourth aspects.

The tool according to the present invention and a method for drying recording sheets using the tool will hereinafter be described.

The tool according to the present invention has openings capable of holding the recording sheets by being raised in a gable form. The method for drying recording sheets according to the present invention comprises assembling the tool so as to raise the openings, with which the tool is equipped, in the gable form and respectively standing recording sheets subjected to printing into the openings, thereby drying the recording sheets subjected to printing.

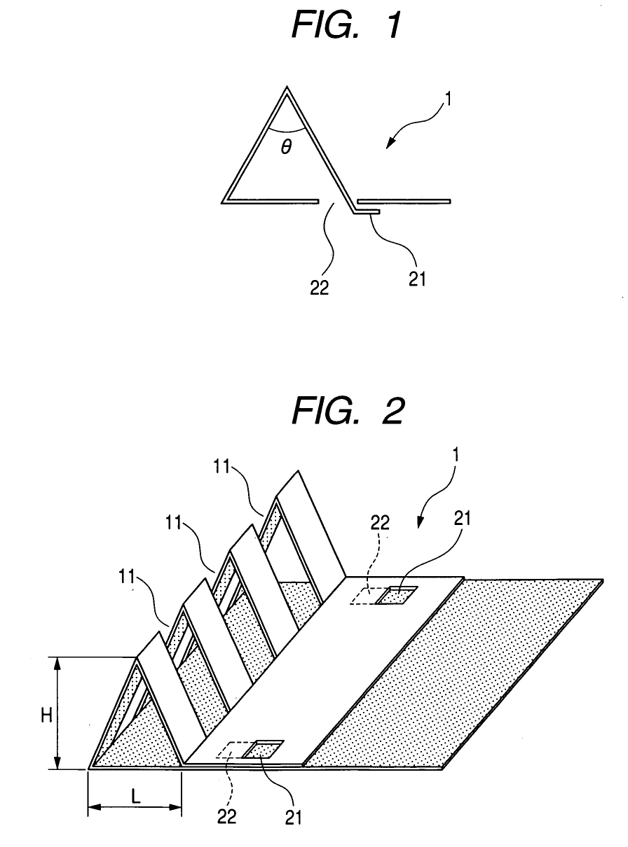

FIG. 2 is a perspective view illustrating the specific construction of a tool according to the present invention, and FIG. 1 is a typical cross-sectional view illustrating a state that a hook has been inserted into a hook hole. This tool 1 has 3 openings 11 in a divided portion raised in a gable form. This divided portion is formed by arranging a mountain fold line between 2 valley fold lines provided in parallel with each other on a sheet and folding the sheet at predetermined angles along the respective fold lines in such a manner that the mountain fold portion becomes an apex. The section thereof is in a triangular gable form.

Hooks 21 and hook holes 22, which pair with each other, are formed at both end portions in an arrangement direction of the divided portion in the vicinity of the sides of the sheet, and the hooks 21 and the hook holes 22 fit with each other in a state that the divided portion has been raised in the gable form. At this time, restoring force intending to return to the original form acts on the gable divided portion. However, a function of a stopper is developed by fitting the hooks 21 into the hook holes 22, so that the gable form is retained. Since the gable divided portion is three-dimensionally formed, the tool is prevented from falling in any direction, and so the form thereof can be stably retained.

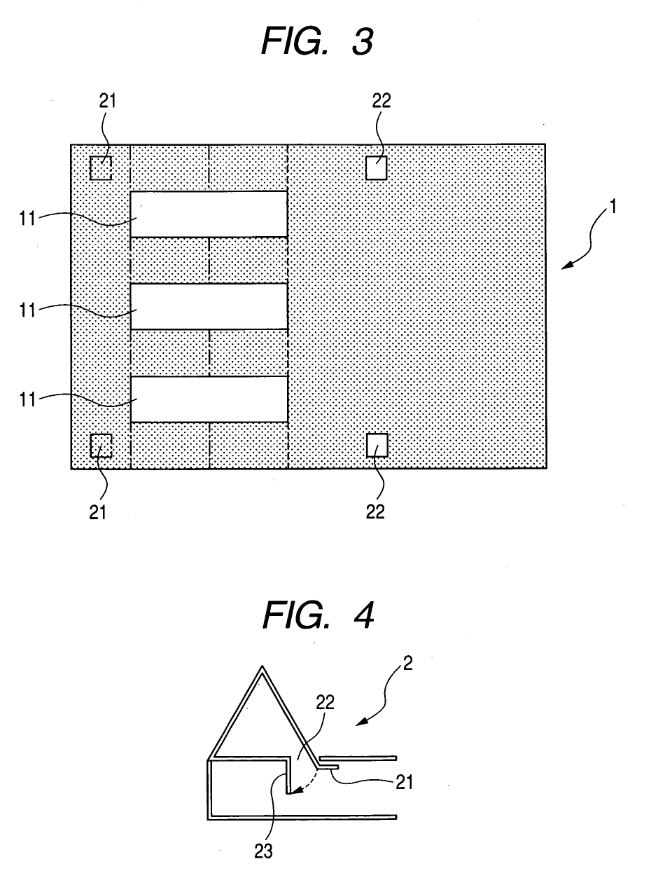

An exemplary flat tool capable of being three-dimensionally assembled as described above is shown in FIG. 3. The tool 1 is equipped with 3 openings having a rectangular form, 2 hooks 21 foldable at a side thereof and 2 hook holes. Each of the openings 11 is formed by drawing an opening cut portion located within border lines to become sides on the side of the opening 11 of the slant faces forming the divided portion in the flat sheet along the border lines. FIG. 3 illustrates a state after the opening cut portions have been drawn. The openings 11 may be formed either by cutting out opening cut portions when forming the flat sheet or by forming a perforation formed of cut portions and uncut portions connecting an opening cut portion to a portion to become a division located on the outside thereof and cutting the opening cut portion out of the flat sheet along the perforation upon assembly of the tool. It is preferable that the openings be formed by cutting out the opening cut portions in advance like the former in such a manner that the outer peripheries of the openings become a smooth cut surface because the contact probability of an opening end with an ink-jet recording sheet is greatly reduced when the tool is assembled from the flat sheet, and the ink-jet recording sheet is inserted into-the opening thereof and taken out of the opening, so that a scratch on a recorded surface due to rubbing is greatly reduced.

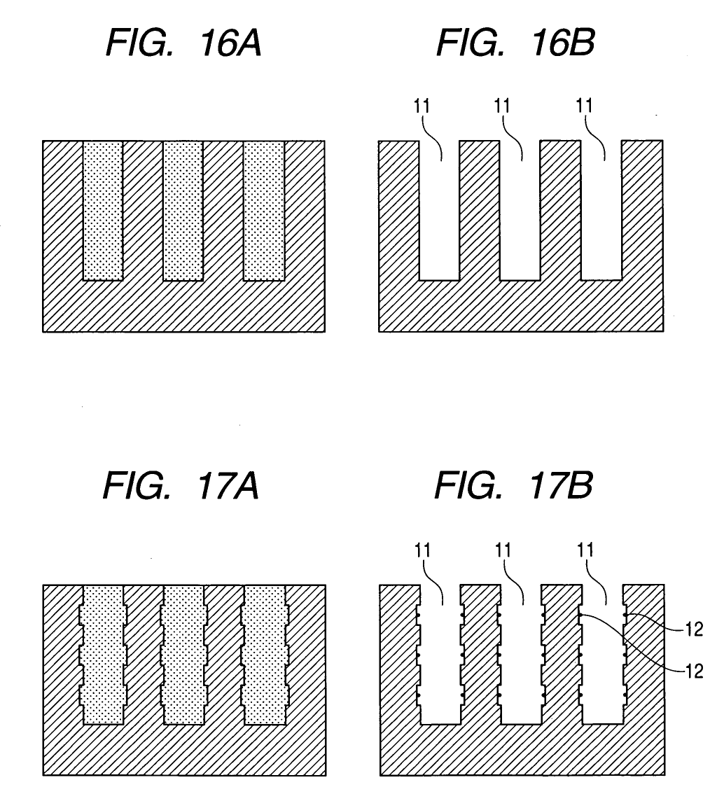

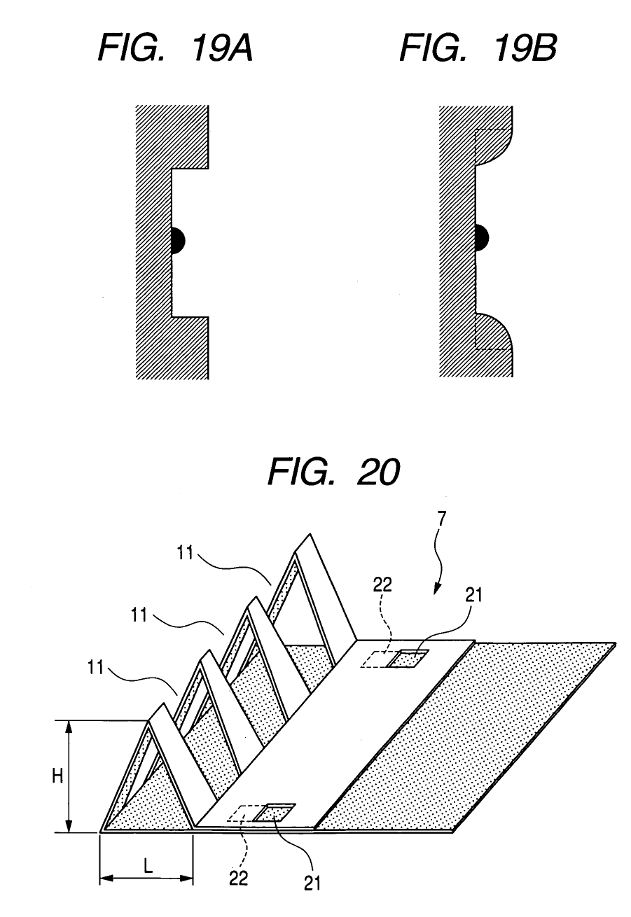

As another embodiment of the border lines defining the opening cut portion, may be mentioned an embodiment that border lines are formed from cut portions and uncut portions connecting an opening cut portion to a portion to become a division located on the outside thereof, and the uncut portions are provided in dented portions with which no recording sheet comes into contact (see FIGS. 17A and 17B). When uncut portions are located in portions with which a recording sheet comes into contact as illustrated in, for example, FIGS. 15A and 15B, cut marks 12 after the uncut portions are cut may often become a projected form the tip of which is pointed, so that the tip may damaged the printed surface in some cases. On the other hand, no uncut portion is provided illustrated in FIGS. 16A and 16B, or uncut portions are provided in dented portions dented inside of a side portion, with which a recording sheet may come into contact, as illustrated in FIGS. 17A and 17B, thereby preventing the printed surface of the recording sheet from being damaged by the cut mark of the uncut portion if any. As illustrated in FIG. 19B, corners of the dented portion are rounded by cutting work, whereby the recording sheet can be more prevented from damaging.

In a state that the openings 11 have been formed, the flat sheet is suitably folded along broken lines in FIG. 3 by mountain folding or valley folding, and the hooks 21 are fitted into the hook holes 22, whereby the tool 1 shown in FIG. 2 can be simply assembled.

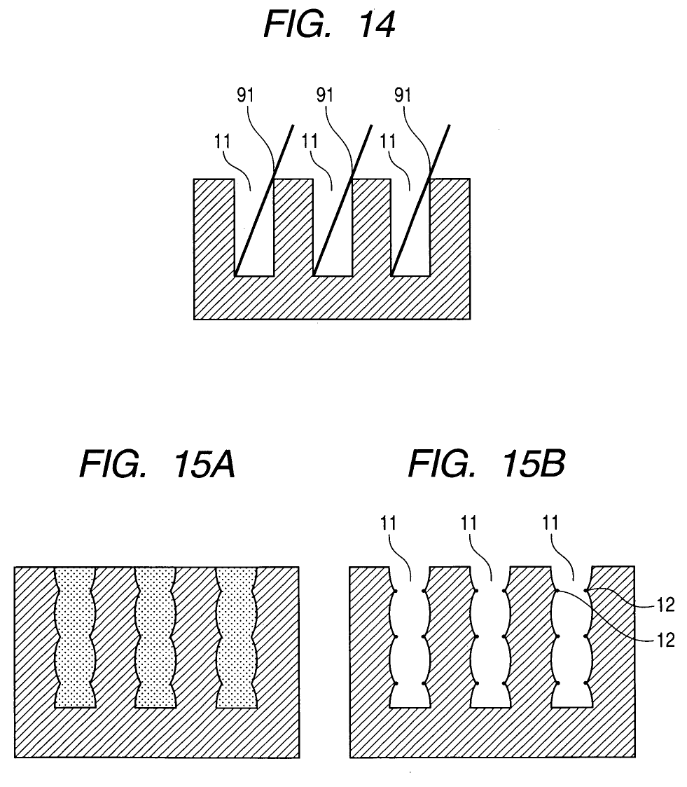

Recording sheets are stood in the openings 11 of the tool 1 raised in the gable form, whereby the recording sheets can be dried. Three recording sheets can be stood at the same time in, for example, the tool shown in FIG. 2 (see FIG. 14). According to this method, the drying efficiency of recording sheets can be much improved.

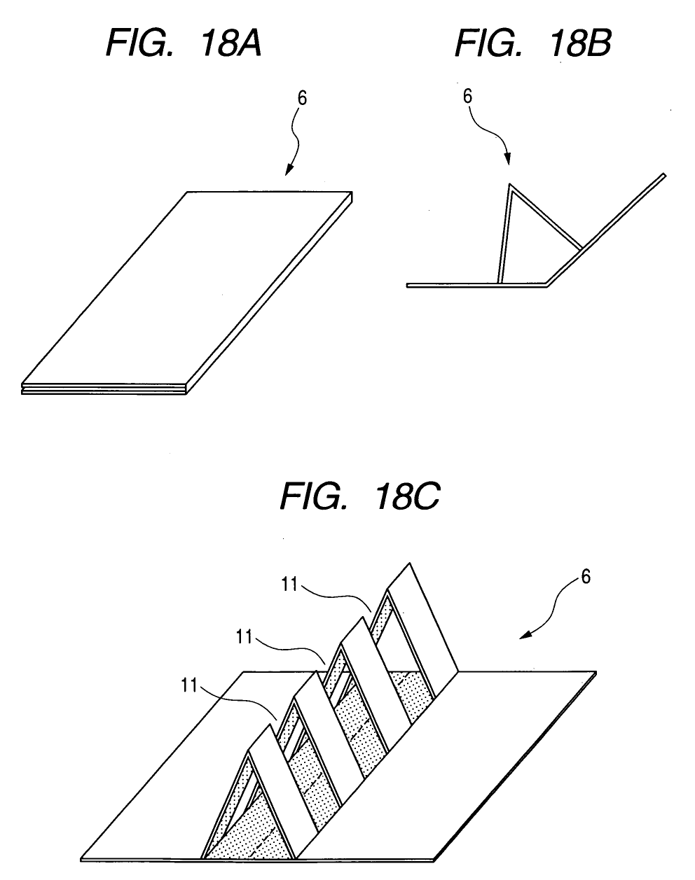

A further embodiment is specifically illustrated in FIGS. 18A to 18C. In this tool, 2 sheet members are foldably bonded to each other, and both ends of a sheet, which becomes a division, are fixed to the sheet members, respectively. The division is in a state that folded and accommodated in the sheet members (FIG. 18A) when the sheet members are folded, the division is raised (FIG. 18B) when the sheet members are opened, thereby forming openings into which recording sheets can be respectively inserted (FIG. 18C). This tool may be fitted to a predetermined surface of a package for recording sheets. The openings in this embodiment may be formed either by drawing opening cut portions in advance or by drawing opening cut portions when raising the division. In the latter case, uncut portions may be used, or uncut portions may be provided in dented portions.

Each of the openings 11 is formed by drawing an opening cut portion located within border lines to become sides on the side of the opening 11 of the slant faces forming the division in the flat sheet along the border lines. FIG. 3 illustrates a state after the opening cut portions have been drawn. The openings 11 may be formed either by cutting out opening cut portions when forming the flat sheet or by forming a perforation formed of cut portions and uncut portions connecting an opening cut portion to a portion to become a division located on the outside thereof and cutting the opening cut portion out of the flat sheet along the perforation upon assembly of the tool. It is preferable that the openings be formed by cutting out the opening cut portions in advance like the former in such a manner that the outer peripheries of the openings become a smooth cut surface because the contact probability of an opening end with an ink-jet recording sheet is greatly reduced when the tool is assembled from the flat sheet, and the ink-jet recording sheet is inserted into the opening thereof and taken out of the opening, so that a scratch on a recorded surface due to rubbing is greatly reduced. When uncut portions are used, or uncut portions are provided in dented portions (see FIGS. 17A and 17B), a portion, with which an ink-jet recording sheet comes into contact, is preferably cut in advance so as to give a smooth cut surface.

On the other hand, an embodiment that a tool is formed in a box form so as to use it as a package for recording sheets-may also be provided. According to such an embodiment, there is no need to separately contain a member to become a tool in a package together with recording sheets, thereby reducing cost.

FIG. 20 is a perspective view illustrating an example of the specific construction of a tool according to the third aspect of the present invention. A typical cross-sectional view of a state that a hook has been inserted into a hook hole is the same as FIG. 1. This tool 7 has 3 openings 11 in a divided portion raised in a gable form. This divided portion is formed by arranging a mountain fold line between 2 valley fold lines provided in parallel with each other on a sheet and folding the sheet at predetermined angles along the respective fold lines in such a manner that the mountain fold portion becomes an apex. The section thereof is in a triangular gable form.

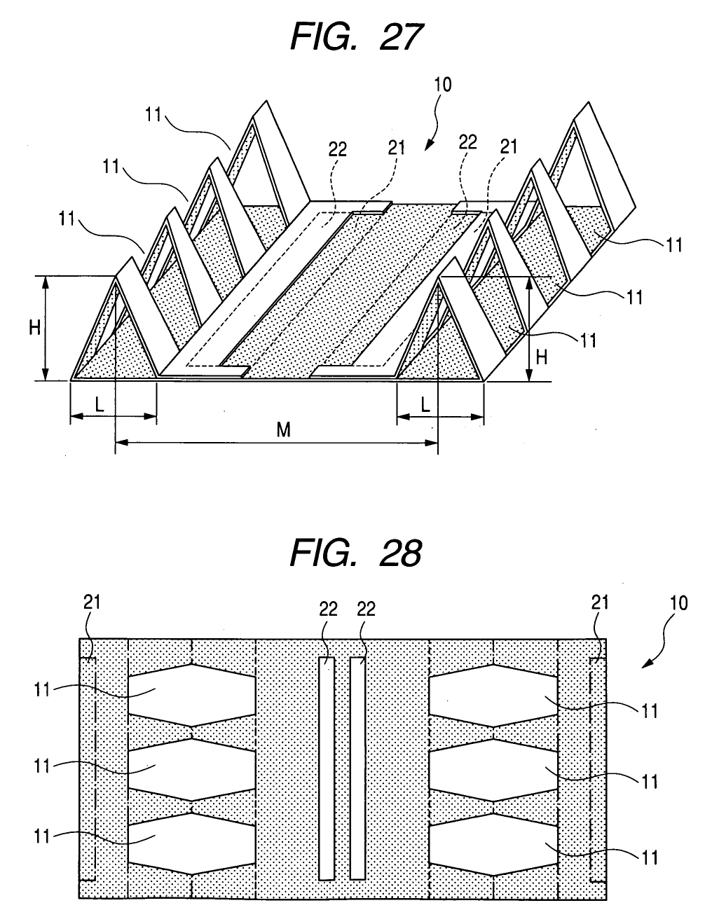

Hooks 21 and hook holes 22, which pair with each other, are formed at both end portions in an arrangement direction of the divided portion in the vicinity of the sides of the sheet, and the hooks 21 and the hook holes 22 fit with each other in a state that the divided portion has been raised in the gable form. At this time, restoring force toward returning to the original form acts on the gable portion. However, a function of a stopper is developed by fitting the hooks 21 into the hook holes 22, so that the gable form is retained. Since the gable portion is three-dimensionally formed, the tool is prevented from falling in any direction, and so the form thereof can be stably retained. A set of a hook and a hook hole may be provided at 3 or more positions as illustrated in, for example, FIG. 24. However, the number of sets is preferably fewer from the viewpoint of handling ability upon assembly. Further, a set of a hook and a hook hole may be provided with a width enlarged in the arrangement direction of the gable divided portion, or may be formed over almost the overall width in the arrangement direction of the divided portion as illustrated in, for example, FIG. 27.

As illustrated, the divided portion has 2 slant faces continuing through a mountain fold line forming an apex line, the hooks 21 are provided at a foot portion of one slant face, and the positions of the hooks are fixed by the respective hook holes, whereby the illustrated gable form can be retained. The form of each opening 11 is defined by sides of the slant faces.

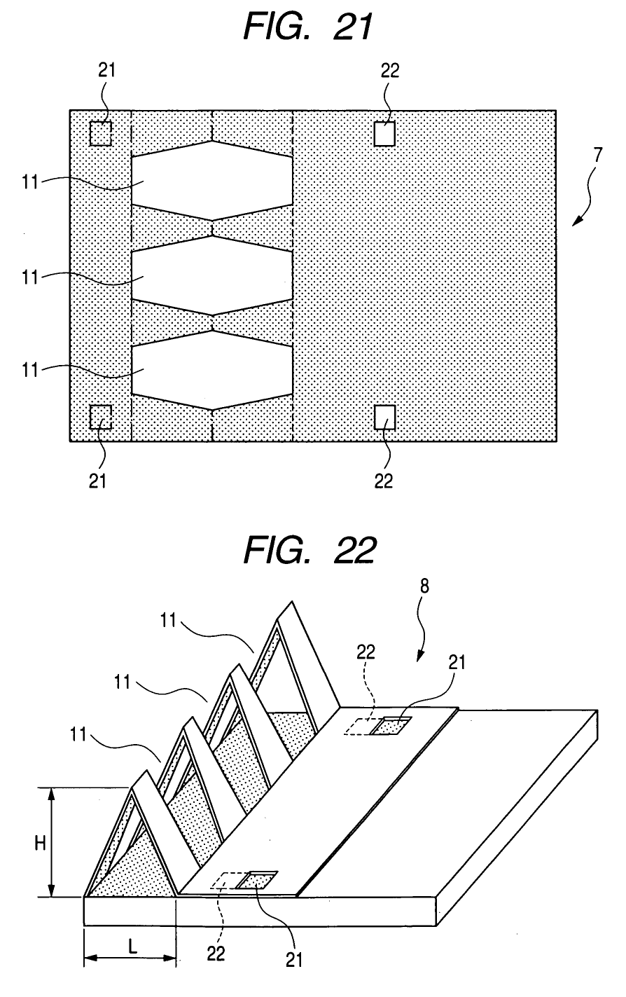

An exemplary development elevation of a package having a flat tool capable of being three-dimensionally assembled as described above is shown in FIG. 21. The tool 7 is equipped with 3 openings having a rectangular form, 2 hooks 21 foldable at a side thereof and 2 hook holes. Each of the openings 11 is formed by drawing an opening cut portion located within border lines to become sides on the side of the opening 11 of the slant faces forming the divided portion in the flat sheet along the border lines. FIG. 21 illustrates a state after the opening cut portions have been drawn. The openings 11 may be formed either by cutting out opening cut portions when forming the flat sheet or by forming a perforation formed of cut portions and uncut portions connecting an opening cut portion to a portion to become a division located on the outside thereof and cutting the opening cut portion out of the flat sheet along the perforation upon assembly of the tool. It is preferable that the openings be formed by cutting out the opening cut portions in advance like the former in such a manner that the outer peripheries of the openings become a smooth cut surface because the contact probability of an opening end with an ink-jet recording sheet is greatly reduced when the tool is assembled from the flat sheet, and the ink-jet recording sheet is inserted into the opening thereof and taken out of the opening, so that a scratch on a recorded surface due to rubbing is greatly reduced.

In a state that the openings 11 have been formed, the flat sheet is suitably folded along broken lines in FIG. 21 by mountain folding or valley folding, and the hooks 21 are fitted into the hook holes 22, whereby the tool 7 shown in FIG. 20 can be simply assembled. According to the construction illustrated in FIG. 22, a tool provided by a separate member on an upper surface of a box body of a package may be assembled and used. Recording sheets are stood in the openings 11 of the tool 7.

raised in the gable form, whereby the recording sheets can be dried. Three recording sheets can be stood at the same time in, for example, the tool shown in FIG. 20. According to this method, the drying efficiency of recording sheets can be much improved.

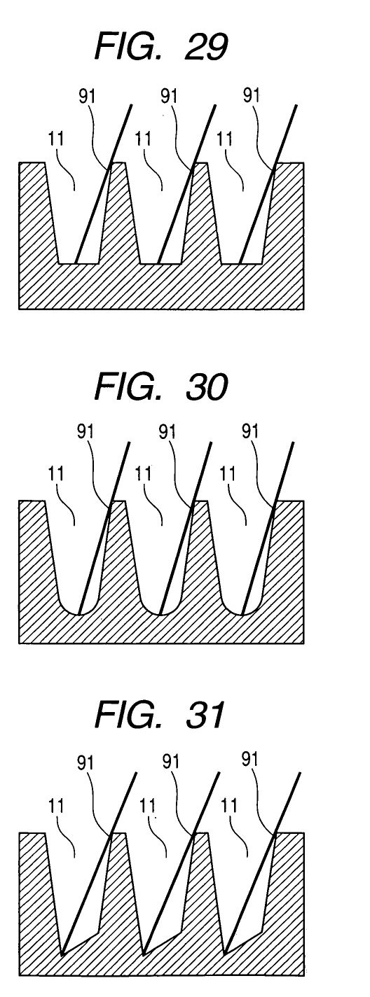

As illustrated in FIG. 29 as a side elevation of a tool after assembly, a distance between sides of slant faces of the divided portion opposing through each of the openings 11 becomes continuously increases the foot portion of the gable form toward an apex thereof. In other words, the opening 11 has a form gradually widening from the bottom thereof toward the apex. Thereby, an inserting operation of recording sheets into the openings 11 for achieving a stood state shown in FIG. 29 and a removing operation from the openings 11 become extremely easy. The form of the divided portion and the positions of the valley fold lines for raising it are suitably set in such a manner that a concavely curved surface or slant surface is formed at the bottom of the opening 11 as illustrated in FIG. 30 or FIG. 31, whereby such a concavely curved surface or slant surface permits stably holding a recording sheet at a standing position (the lowest portion of the concave surface or slant surface) suitable for drying of the recording sheet, where the lower end of the recording sheet is located. In the tools illustrated in FIGS. 29 to 31, both sides of slant faces of the divided portion opposing through the opening 11 form a predetermined angle with the bottom surface of the gable form. However, one side may be perpendicular. As examples of such embodiments, may be mentions tools 22 to 24 used in EXAMPLEs 22 to 24.

The tools according to the present invention can be used for drying various kinds of recording sheets such as ink-jet recording sheets and recording sheets for photographs. In particular, they can be preferably used in drying of ink-jet recording sheets that have had many problems in drying method, and can be particularly preferably used in drying of ink-jet recording sheets capable of double-side printing.

No particular limitation is imposed on the ink-jet recording sheets, and the present invention may be applied to recording sheets of any sizes such as A series sizes, B series sizes, letter size, postal card size, and L size, 2L size, 4×6 cm size, 8×10 inch size and 10×12 inch size, to which silver halide photographs are accustomed. It is only necessary to adjust the size and form of the tool to the size of the recording sheet.

No particular limitation is also imposed on the kind of the material of the ink-jet recording sheet. However, the present invention is preferably applied to ink-jet recording sheets using resin-coated paper as a base material in view of curling after drying, etc.

Since recording sheets are dried in a stood state, the recording sheets preferably have some rigidity (stiffness). The rigidity is preferably 300 to 5,000 mgf, more preferably 300 to 4,000 mgf in accordance with the measuring method prescribed in J. TAPPI No. 40. In the case of an ink-jet recording sheet, the rigidity is particularly preferably 500 to 3,000 mgf from the viewpoints of conveying ability in an ink-jet printer, etc. A proper thickness is also important for realizing high restoring force. In the case of, for example, an ink-jet recording sheet, the thickness is preferably 100 to 500 μm. The thickness is more preferably 180 to 350 μm in view of conveying ability in an ink-jet printer, curling after drying, etc. The thickness is particularly preferably 200 to 300 μm.

As a material of the tool, may be used paper such as art paper, glossy paper, bond paper, regenerated paper, baryta paper, cast-coated paper, coated board, corrugated fiberboard, paperboard, tree free paper or synthetic paper; a resin such as polyethylene terephthalate, diacetate, triacetate, celluloid, polycarbonate, polyimide, polyacrylate, polyethylene, polypropylene or ABS; or a rubbery elastic substance.

Either a tool composed of an absorptive member to easily absorb water or a tool composed of a non-absorptive member to hardly absorb water may also be used. However, the tool composed of the absorptive member to hardly cause unevenness of drying on a recording sheet is preferably used. Even in the non-absorptive member, however, it is likewise hard to cause the unevenness of drying on a recording sheet when the surface thereof is subjected to a hydrophilizing treatment.

The surface of the tool may be smooth or irregular, and the tool may be transparent, translucent or opaque. The tool may also be made from a material obtained by laminating two or more such materials on each other. Further, various kinds of decoration and coloring may be applied as a part of interior.

In the case where the material of the tool is paper, cardboard such as coated board or paperboard may preferably be used in view of strength and cost. The thickness thereof is preferably 0.2 to 2 mm, more preferably 0.3 to 1 mm from the viewpoints of the strength of the tool, easy processing and cost.

No particular limitation is imposed on the number of openings with which one tool is equipped, and the number of openings, and the number of openings is preferably as large as possible within a range capable of stably standing recording sheets from the viewpoint of enhancing drying efficiency and in view of, for example, the dimensions preventing recording sheets from being scratched upon insertion and removal thereof.

The openings may be formed in advance by punching or the like, or may be formed as portions capable of being cut out by making perforations or cut portions in a flat sheet in such a manner that the portions to become openings may be drawn upon use to form the openings.

No particular limitation is imposed on the form and size of the openings, and these may be suitably set within a range capable of developing the function of the invention of the present application.

The number of uncut portions in an opening is not particularly limited so far as an opening cut portion can be firmly fixed and simply drawn. However, the number thereof is desirably even so that an uncut portion is not located at an apex when the gable is formed. Assuming that the number of uncut portions is n, it is preferable to satisfy 6≦n≦30. As that time, the size of the dented portion is preferably at most [(longer width of the opening)/(2n+1)].

L and H (see FIG. 2) when the gable is formed are not particularly limited so far as a recording sheet can be sufficiently stably held. Assuming that a length in an L direction and a length in an H direction of a recording sheet to be held are A and H, respectively, it is preferable to satisfy A/10≦L and B/4≦H. It is more preferable to satisfy A/10≦L≦A and B/3≦H≦B. It is still more preferable to satisfy A/5≦L≦4A/5 and B/3≦H≦B.

In the tool 1 shown in FIG. 2, the gable divided portion forms one row. However, a tool 5, in which the gable divided portion forms 2 rows as illustrated in FIGS. 11 to 13, can also be used. Printed sheets of a large size can be stably stood in such a tool 5, and so the tool 5 is suitable for use in drying such recording sheets.

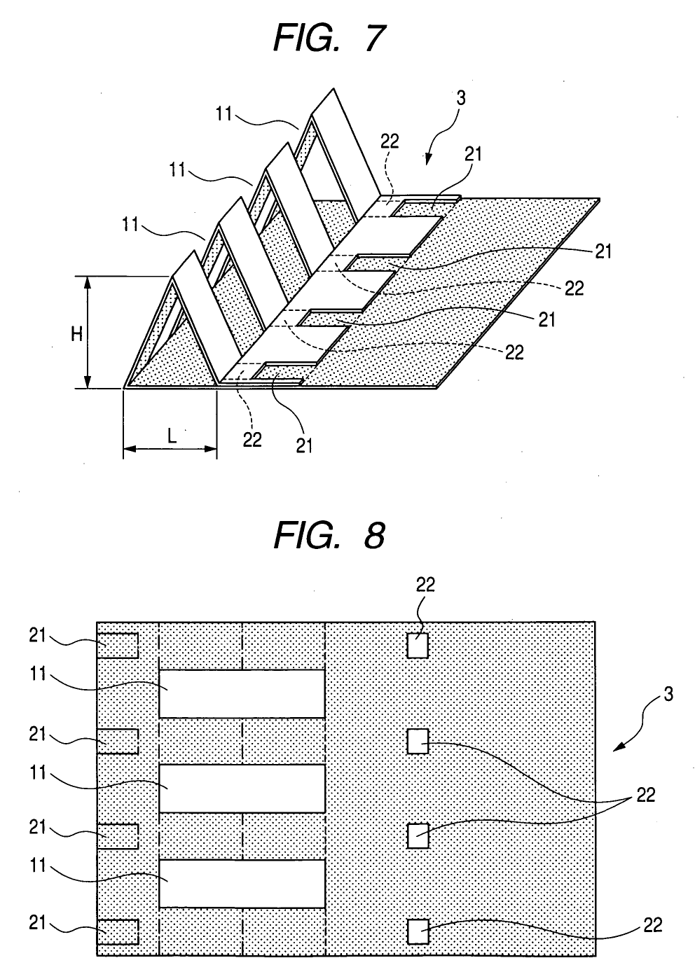

The forms of the hook and hook hole may be suitably set so as to develop a function of a stopper against the restoring force of the gable divided portion functioning to return to the original form by the fitting between them. The set of a hook and a hook hole may be provided at 3 or more positions. However, the number of sets is preferably as small as possible from the viewpoint of handling ability in assembly. It is generally only necessary to provide the set at 2 positions of ends of the tool as illustrated in FIG. 2 though it varies according to the size of the tool. However, when the tool is large like a tool for holding large recording sheets of, for example, A3 size, in which 2 positions do not suffice for the strength of the tool and the ability to hold recording sheets upon standing of the recording sheets, a set of a hook and a hook hole may be suitably provided at a position corresponding to the hook holes 22 and located at the opening 11 or between the openings 11 in FIG. 3, so as to give the tool a strength capable of standing the recording sheets. Further, a set of a hook and a hook hole may be provided with a width enlarged in the arrangement direction of the gable divided portion, or may be formed over almost the overall width in the arrangement direction of the divided portion as provided in, for example, a tool 5 illustrated in FIGS. 11 to 13. The set may also be formed with the longer side. perpendicular to the arrangement direction as provided in, for example, a tool 3 illustrated in FIGS. 7 and 8.

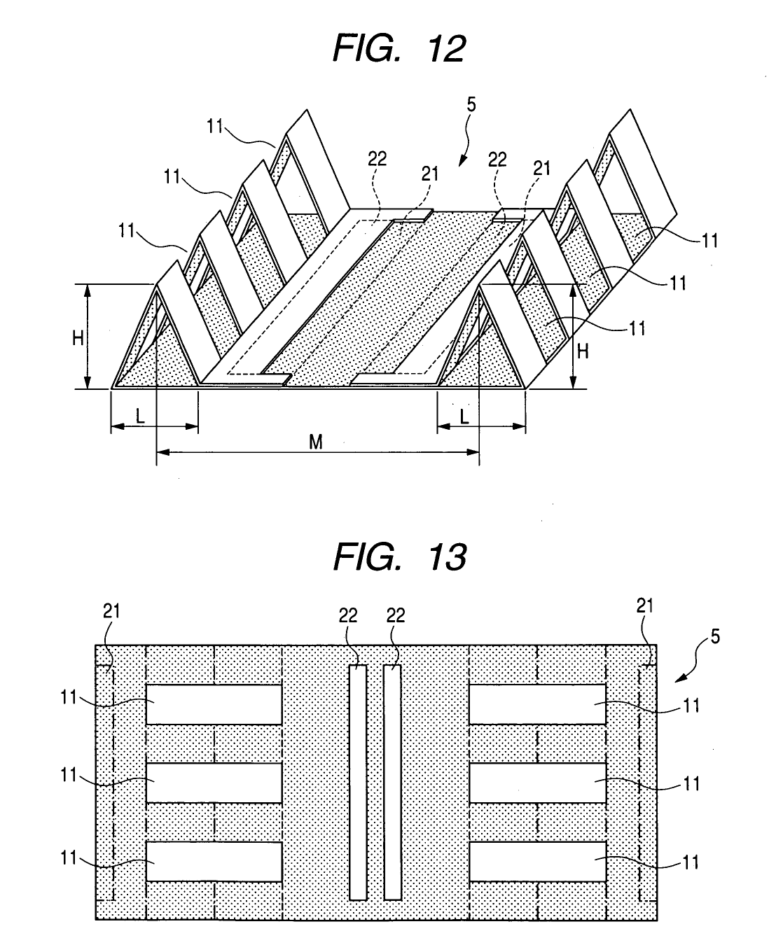

In order to more stably stand recording sheets in the tool, it is more preferable to provide 2 gable forms in the tool as illustrated in FIG. 12. No particular limitation is imposed on a distance M between apexes of the gables so far as it falls within a range capable of stably standing the recording sheets. It is within a range of preferably A/4≦M≦A, more preferably A/3≦M≦A.

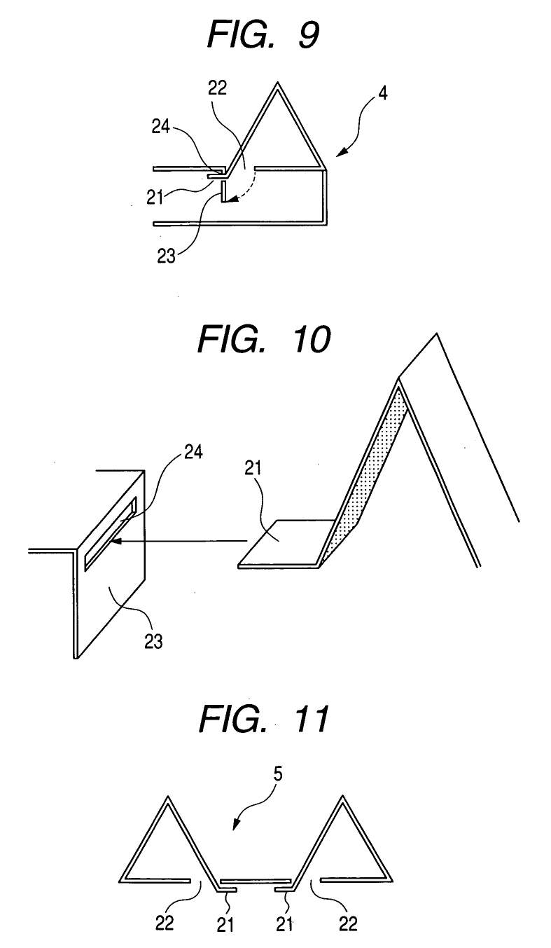

The tools according to the present invention may be in the form of a sheet or a box. As the tool in the form of the box, may be mentioned, for example, such a tool 2 as illustrated in FIGS. 4 to 6. In this case, hook holes 22 may be those initially formed. However, folding portions 23 capable of being folded into the box may also be provided to fold them into the box in use, thereby forming hook holes 22. Further, a hook inserting hole 24 may be formed in the folding portion 23, thereby providing a tool 4, in which the hook 21 can be inserted into the hook inserting hole 24 (see FIGS. 9 and 10). In such a tool 4, the fitted state between the hook 21 and the hook hole 22 becomes firmer to increase the stability of the gable divided portion.

As described above, each of the tools comes to be used in a three-dimensional form. However, it is convenient that the tool can be returned to the flat form. The tool that can be reversibly changed between the three-dimensional form and the flat form can be easily stored into a package of recording sheets.

The tool formed in a box form may also be used as a package for recording sheets. According to such an embodiment, there is no need to separately contain a member to become a tool in a package together with recording sheets, thereby reducing cost.

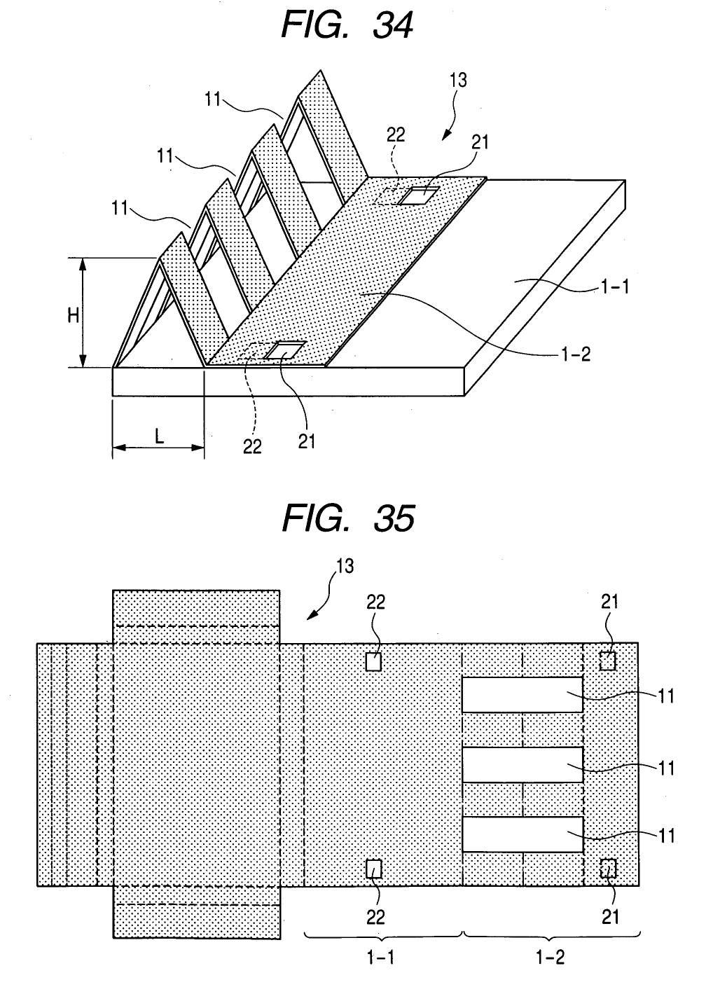

FIG. 34 is a perspective view illustrating an example of the specific construction of a tool according to the fifth aspect of the present invention, and FIG. 33 is a typical cross-sectional view illustrating a state that a hook has been inserted into a hook hole. This tool 13 has 3 openings 11 in a divided portion raised in a gable form. This divided portion is formed by arranging a mountain fold line between 2 valley fold lines provided in parallel with each other on a sheet and folding the sheet at predetermined angles along the respective fold lines in such a manner that the mountain fold portion becomes an apex. The section thereof is in a triangular gable form. In other words, θ in FIG. 33 is an apex angle forming an apex line formed by mountain folding, and a state that a hook 21 has been inserted into a hook hole 22 is illustrated in this cross-sectional view.

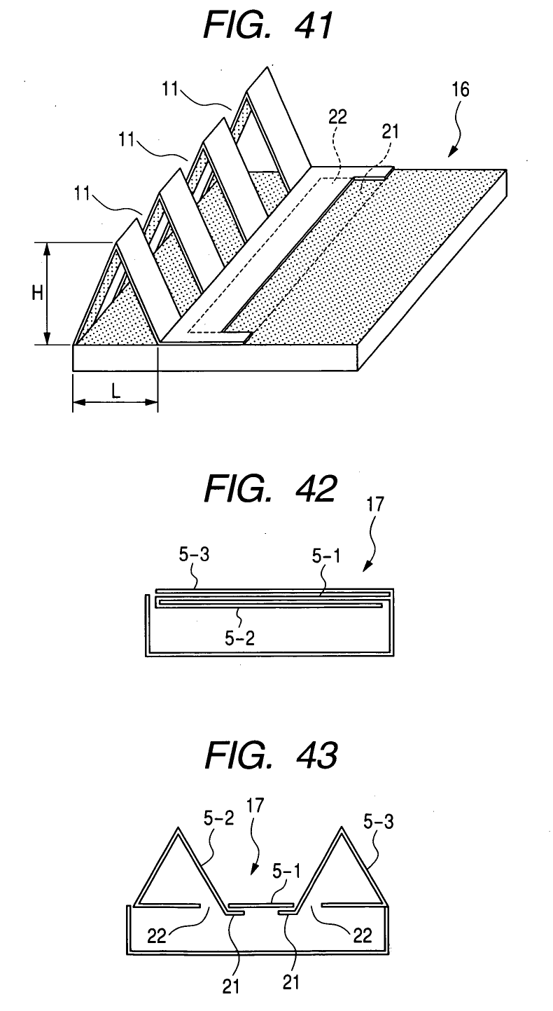

Hooks 21 and hook holes 22, which pair with each other, are formed at both end portions in an arrangement direction of the divided portion in the vicinity of the sides of the sheet, and the hooks 21 and the hook holes 22 fit with each other in a state that the divided portion has been raised in the gable form. At this time, restoring force functioning to return to the original form acts on the gable portion. However, a function of a stopper is developed by fitting the hooks 21 into the hook holes 22, so that the gable form is retained. Since the gable portion is three-dimensionally formed, the tool is prevented from falling in any direction, and so the form thereof can be stably retained. A set of a hook and a hook hole may be provided at 3 or more positions as illustrated in, for example, FIG. 40. However, the number of sets is preferably as small as possible from the viewpoint of handling ability upon assembly. Further, a set of a hook and a hook hole may be provided with a width enlarged in the arrangement direction of the gable divided portion, or may be formed over almost the overall width in the arrangement direction of the divided portion as illustrated in, for example, FIG. 41.

As illustrated, the divided portion has 2 slant faces continuing through a mountain fold line forming an apex line, the hooks 21 are provided at a foot portion of one slant face, and the positions of the hooks are fixed by the respective hook holes, whereby the illustrated gable form can be retained.

An exemplary development elevation of a package having a flat tool capable of being three-dimensionally assembled as described above is shown in FIG. 35. The tool 13 is equipped with 3 openings having a rectangular form, 2 hooks 21 foldable at a side thereof and 2 hook holes. The openings 11 may be formed in advance by punching or the like or may be formed by drawing opening cut portions located within border lines to become sides on the side of the opening 11 of the slant faces forming the divided portion in the flat sheet along the border lines. It is convenient that the border lines defining the opening cut portions are formed by perforations or cut portions in such a manner that the opening cut portions may be easily drawn.

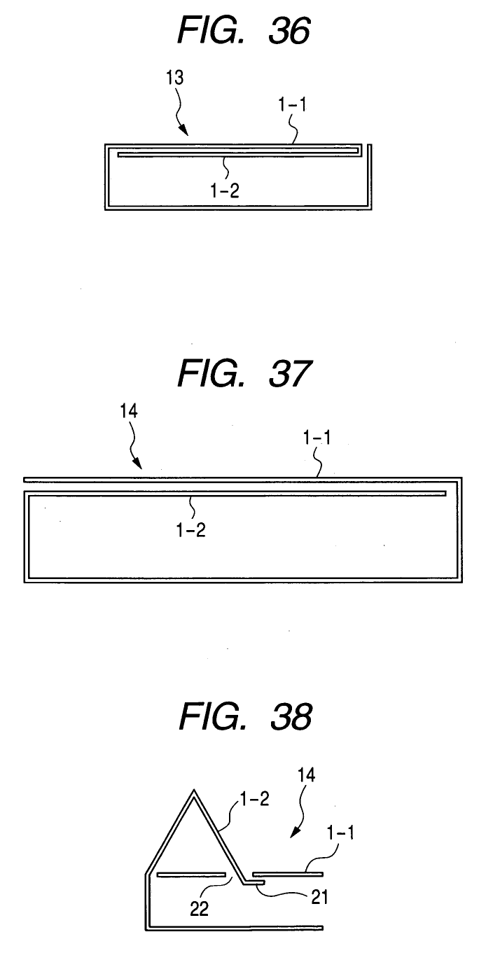

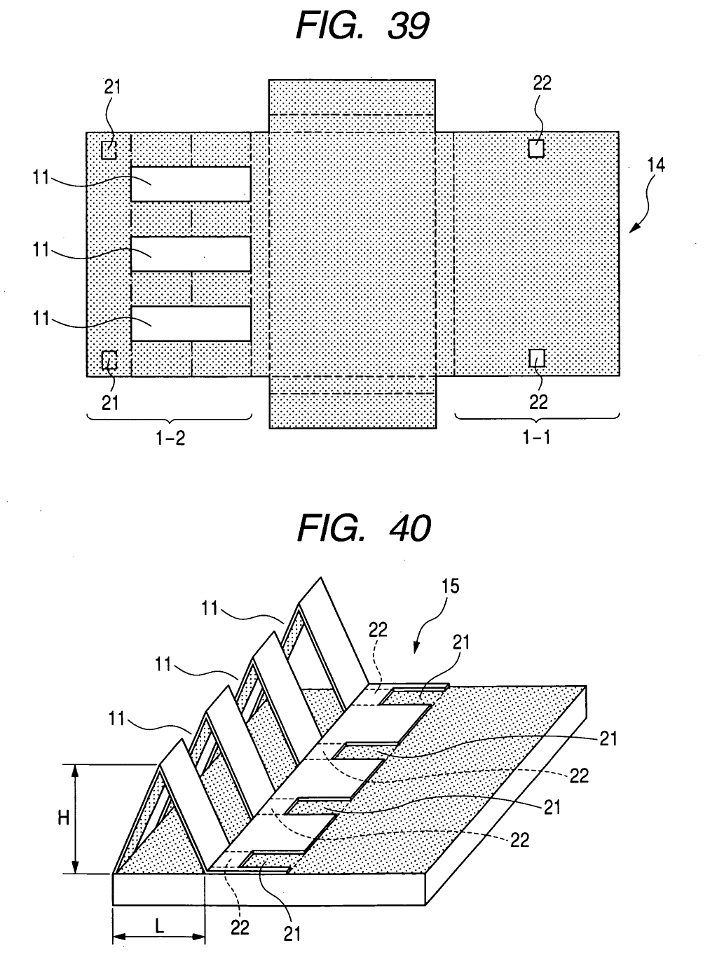

In a state that the openings 11 have been formed, the flat sheet is suitably folded along broken lines in FIG. 35 by mountain folding or valley folding, and the hooks 21 are fitted into the hook holes 22, whereby the tool 13 shown in FIG. 34 can be simply assembled. According to the construction illustrated in FIGS. 33 to 35, a tool provided by a separate member on an upper surface of a box body of a package may be assembled and used. As an embodiment upon distribution as packages, may be mentioned an embodiment that a divided portion 1-2 of a tool is folded and contained in the inside of an upper door leaf portion 1-1 of a box as illustrated in FIG. 36, the door leaf portion 1-1 is opened upon use to fold up the divided portion 1-2 on an upper surface of the door leaf portion, opening cut portions for forming openings are drawn out as needed, and the division is raised along the predetermined mountain fold line and valley fold lines to form the openings. An embodiment that a divided portion 1-2 of a tool like a development elevation illustrated in FIG. 39 is arranged on a side surface opposing to an upper door leaf 1-1 of a box, and the divided portion 1-2 is folded and contained in the inside of the door leaf portion 1-1 as illustrated in FIG. 37 may also be mentioned. In this case, the door leaf portion 1-1 is opened upon use to fold up the divided portion 1-2 on an upper surface of the door leaf portion, opening cut portions for forming openings are drawn out as needed, and the division is raised along the predetermined mountain fold line and valley fold lines, whereby the openings can be formed as illustrated in a typical cross-sectional view of FIG. 38. In any case, it may be returned to its original package form (the form illustrated in FIG. 36 or 37) after the tool is assembled.

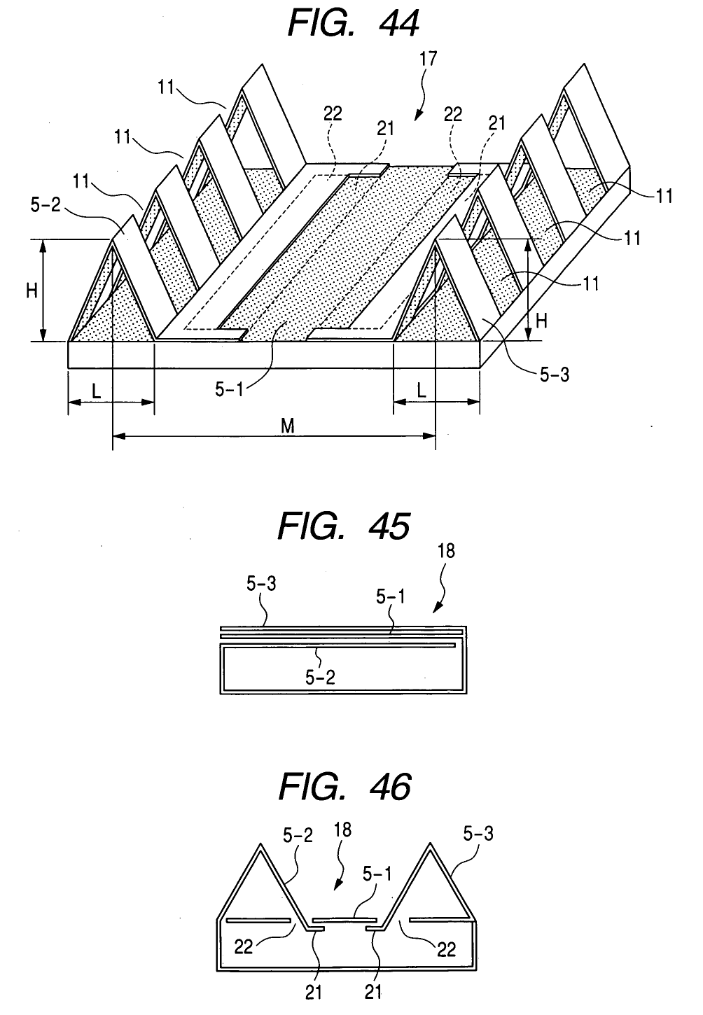

Recording sheets are stood in the openings 11 of the tool 13 raised in the gable form, whereby the recording sheets can be dried. Three recording sheets can be stood at the same time in, for example, the tool shown in FIG. 34. According to this method, the drying efficiency of recording sheets can be much improved. In the tool 13 shown in FIG. 34, the gable divided portion forms one row. As illustrated in FIG. 42, however, a door leaf portion 5-1, a divided portion 5-2 and a divided portion 5-3 may also be arranged to provide 2 rows of the division in opposed relation to each other as illustrated in FIGS. 43 and 44. Printed sheets of a large size can be stably stood in a tool 17 having plural rows of the division as described above, and so the tool 17 is suitable for use in drying such recording sheets. The door leaf portion 5-1 and the divided portions 5-2 and 5-3 may be arranged as illustrated in a cross-sectional view of FIG. 45 to assemble a tool as illustrated in FIG. 46. In any case, it may be returned to its original form (the form illustrated in FIG. 42 or 45) after the tool is assembled.

The forms of the hook and hook hole may be suitably set so as to develop a function of a stopper against the restoring force of the gable divided portion functioning to return to the original form by the fitting between them. More specifically, either the hooks 21 and the hook holes 22, with which the tool 13 shown in FIGS. 33 to 35 is equipped, or the hooks 21 and the hook holes 22 in a rectangular form long in a direction perpendicular to the portion to become the gable, with which the tool 15 shown in FIG. 40 is equipped, can be used. Alternatively, the hook 21 and the hook hole 22 in a rectangular form long in a direction parallel to the portion to become the gable, with which the tool 16 shown in FIG. 41 is equipped, can also be used. Hooks and hook holes are formed so as to pair with each other, and the numbers thereof are generally the same. The numbers of hooks and hook holes, with which a tool is equipped, are preferably as small as possible from the viewpoint of handling ability upon assembly. It is generally only necessary to provide the set at 2 positions of ends of the tool as illustrated in FIG. 34 though it varies according to the size of the tool However, when the tool is large like a tool for holding large recording sheets of, for example, A3 size, in which 2 positions do not suffice-for the strength of the tool and the ability to hold recording sheets in standing of the recording sheets, a set of a hook and a hook hole may be suitably provided at a position corresponding to the hook holes 22 and located at the opening 11 or between the openings 11 in FIG. 35, so as to give the tool the strength capable of standing the recording sheets.

In order to more stably stand recording sheets in the tool, it is more preferable to provide 2 gable forms in the tool as illustrated in FIG. 44. No particular limitation is imposed on a distance M between apexes of the gables so far as it falls within a range capable of stably standing the recording sheets. It is within a range of preferably A/4≦M≦A, more preferably A/3≦M≦A.

The hook holes 22 may be those initially formed. As illustrated in FIG. 4, however, folding portions 23 capable of being folded into the box may also be provided to fold them into the box upon use, thereby forming hook holes 22. Further, a hook inserting hole 24 may be formed in the folding portion 23, thereby providing a tool 4, in which the hook 21 can be inserted into the hook inserting hole 24 (see FIGS. 9 and 10). In such a tool 4, the fitted state between the hook 21 and the hook hole 22 becomes firmer to increase the stability of the portion to become the gable.

As described above, each of the tools is used in a three-dimensional form. However, it is convenient that the tool can be returned to the flat form. The tool that can be reversibly changed between the three-dimensional form and the flat form can be easily stored into a package of recording sheets. Since the divided portion of the tool have folded lines after assembly, and openings are formed therein, this is provided as a member separate from a box body of a package, and it is returned into the inside of the box body again after assembly and use (a state illustrated in, for example, FIG. 36), whereby the function and outward appearance as the package are not lost. For example, when the folded lines are severely created after the tool is assembled and returned to the flat form, and this flat tool is used as one surface of a box body of a package, the function as the box may be lost in some cases. On the other hand, in the present invention, the tool is formed as a part of the package, and so there is no need to separately contain a member to become a tool in a package together with recording sheets, thereby reducing cost.

The present invention will hereinafter be described in more detail by the following examples.

≦Tool According to First Aspect>

[Production of Tools 1 to 5]

A coated board (thickness: about 380 μm) was used to produce Tools 1 to 5. The forms and sizes of respective portions were set as described below.

(Tool 1)

Form: a form illustrated in FIG. 2.

Form of a gable: L=6 cm, H=7 cm.

Opening: 1.5×15.3 cm.

Hook: 1.5×2 cm.

Hook hole: 1.6×1.5 cm.

(Tool 2)

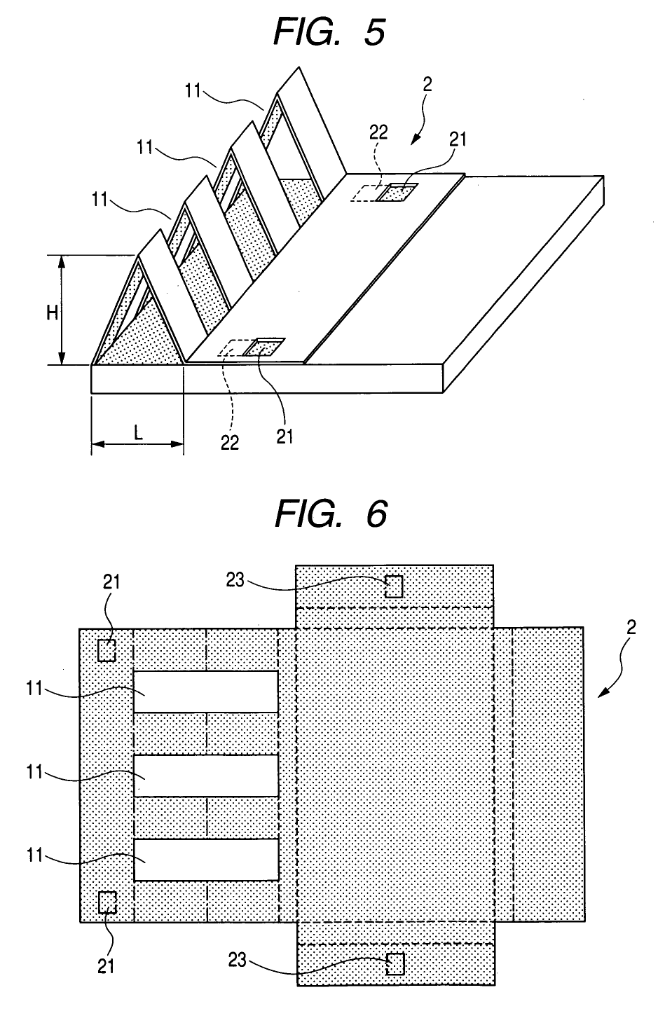

Form: a form illustrated in FIG. 5.

Form of a gable: L=6 cm, H=7 cm.

Opening: 1.5×15.3 cm.

Hook: 1.5×2 cm.

Hook hole: 1.6×1.5 cm.

(Tool 3)

Form: a form illustrated in FIG. 7.

Form of a gable: L=6 cm, H=7 cm.

Opening: 1.5×15.3 cm.

Hook: 1.5×2 cm.

Hook hole: 1.6×1.5 cm.

(Tool 4)

Form: a form illustrated in FIG. 5 (however, only hook holes were formed as shown in FIG. 10).

Form of a gable: L=6 cm, H=7 cm.

Opening: 1.5×15.3 cm.

Hook: 1.4×1.5 cm.

Hook hole: 2×1.5 cm.

Hook inserting hole: 1.6×0.2 cm.

(Tool 5)

Form: a form illustrated in FIG. 12 (dimensions of respective portions forming 2 gables were set equally).

Form of a gable: L=3 cm, H=5.3 cm, M=18 cm.

Opening: 1.5×11 cm.

Hook: 17.6×1 cm.

Hook hole: 18×1 cm.

### EXAMPLES 1 to 5

In EXAMPLES 1 to 5, Tools 1 to 5 were respectively assembled, and 3 A4-sized ink-jet recording sheets (trade name: SP-101, product of Canon Inc.) were stood in openings in each of the tools to observe a condition thereof. The results are shown in Table 1.

### Comparative Example 1

Such a sheet member as described in Japanese Patent Application Laid-Open No. 2003-276777, which was provided with comb-like supporting pieces formed in at least 2 rows by making a great number of cuts in substantially the same direction, was produced, and 3 ink-jet recording sheets were stood therein to observe a condition thereof. The results are shown in Table 1.

[Evaluation items]

(Stability of Tool)

Whether the form of a tool was changed or not was observed to make evaluation in accordance with the following standard.

⊚: The form was scarcely changed;

∘: Change in the form was slightly observed, but the form was sufficiently stable; and

×: The form was unstable, and readjustment was required.

(Stability of Recording Sheet)

The condition of the recording sheets stood was observed to make evaluation in accordance with the following standard.

⊚: Stably held; and

×: Unstably held.

TABLE 1

| | Stability of | Stability of recording |
|---|---|---|
| | tool | sheet |
| EXAMPLE 1 | ◯ | ◯ |
| EXAMPLE 2 | ◯ | ◯ |
| EXAMPLE 3 | ◯ | ◯ |
| EXAMPLE 4 | ⊚ | ◯ |
| EXAMPLE 5 | ⊚ | ◯ |
| COMP. EXAMPLE 1 | X | X |

As described above, the tools according to the first aspect permit simply and stably standing recording sheets therein to dry them. All the tools used in EXAMPLEs 1 to 5 were very stable gable tools that the restoring force functioning to return to the flat form of the apex folded by folding in the gable form can be utilized by fitting the hook into its corresponding hook hole to retain the gable form.

≦Tool According to Second Aspect>

[Production of Tools 11 to 20]

A coated board (thickness: about 380 μm) was used to produce Tools 11 to 20. The forms and sizes of respective portions were set as described below.

(Tool 11)

Form: a form illustrated in FIG. 2.

Form of a gable: L=6 cm, H=7 cm.

Opening: 1.5×15.3 cm.

The number of uncut portions: n=0 (straight cut).

Hook: 1.5×2 cm.

Hook hole: 1.6×1.5 cm.

(Tool 12)

Form: a form illustrated in FIG. 5.

Form of a gable: L=6 cm, H=7 cm.

Opening: 1.5×15.3 cm.

The number of uncut portions: n=0 (straight cut).

Hook: 1.5×2 cm.

Hook hole: 1.6×1.5 cm.

(Tool 13)

Form: a form illustrated in FIG. 7.

Form of a gable: L=6 cm, H=7 cm.

Opening: 1.5×15.3 cm.

The number of uncut portions: n=0 (straight cut).

Hook: 1.5×2 cm.

Hook hole: 1.6×1.5 cm.

(Tool 14)

Form: a form illustrated in FIG. 5 (however, only hook holes were formed as shown in FIG. 10).

Form of a gable: L=6 cm, H=7 cm.

Opening: 1.5×15.3 cm.

The number of uncut portions: n=0 (straight cut).

Hook: 1.5×2 cm.

Hook hole: 1.6×1.5 cm.

(Tool 15)

Form: a form illustrated in FIG. 12.

Form of a gable: L=6 cm, H=7 cm, M=15 cm.

Opening: 1.5×15.3 cm.

The number of uncut portions: n=0 (straight cut).

Hook: 25.6×1 cm.

Hook hole: 26×1 cm.

(Tool 16)

Form: a form illustrated in FIG. 18.

Form of a gable: L=6 cm, H=7 cm.

Width of opening: 1.5 cm.

(Tool 17)

Form: a form illustrated in FIG. 2 (however, only openings were formed as shown in FIG. 19A).

Form of a gable: L=6 cm, H=7 cm.

Opening: 1.5×15.3 cm.

The number of uncut portions: n=10.

Dented portion: 0.7×0.3 cm.

Hook: 1.5×2 cm.

Hook hole: 1.6×1.5 cm.

(Tool 18)

Form: a form illustrated in FIG. 5 (however, only openings were formed as shown in FIG. 19A).

Form of a gable: L=6 cm, H=7 cm.

Opening: 1.5×15.3 cm.

The number of uncut portions: n=10.

Dented portion: 0.7×0.3 cm.

Hook: 1.5×2 cm.

Hook hole: 1.6×1.5 cm.

(Tool 19)

Form: a form illustrated in FIG. 7 (however, only openings were formed as shown in FIG. 19B)

Form of a gable: L=6 cm, H=7 cm.

Opening: 1.5×15.3 cm.

The number of uncut portions: n=10.

Dented portion: 0.7×0.3 cm.

Hook: 1.5×2 cm.

Hook hole: 1.6×1.5 cm.

(Tool 20)

Form: a form illustrated in FIG. 12 (however, only openings were formed as shown in FIG. 19B).

Form of a gable: L=6 cm, H=7 cm, M=15 cm.

Opening: 1.5×15.3 cm.

The number of uncut portions: n=10.

Dented portion: 0.7×0.3 cm.

Hook: 1.5×2 cm.

Hook hole: 1.6×1.5 cm.

### EXAMPLES 11 to 20

In EXAMPLES 11 to 20, Tools 11 to 20 were respectively assembled, and 3 A4-sized ink-jet recording sheets (trade name: SP-101, product of Canon Inc.) were stood in openings in each of the tools to observe a condition thereof. The results are shown in Table 2.

### Comparative Example 11

Such a sheet member as described in Japanese Patent Application Laid-Open No. 2003-276777, which was provided with comb-like supporting pieces formed in at least 2 rows by making a great number of cuts in substantially the same direction, was produced, and 3 ink-jet recording sheets were stood therein to observe a condition thereof. The results are shown in Table 2.

[Evaluation Items]

With respect to the tools, Stability of tool and Stability of recording sheet were evaluated in accordance with the standards described above.

(Surface scratch)

Whether the surface of each of the recording sheets and end portions thereof were scratched or not was observed to make evaluation in accordance with the following standard.

⊚: The surface of the recording sheet and end portions thereof were scarcely scratched;

◯: The surface of the recording sheet and end portions thereof were slightly scratched; and

×: The surface of the recording sheet and end portions thereof were scratched.

TABLE 2

| | | Stability of | |
|---|---|---|---|
| | Stability of tool | recording sheet | Surface scratch |
| EX. 11 | ◯ | ◯ | ⊚ |
| EX. 12 | ◯ | ◯ | ⊚ |
| EX. 13 | ◯ | ◯ | ⊚ |
| EX. 14 | ⊚ | ◯ | ⊚ |
| EX. 15 | ⊚ | ◯ | ⊚ |
| EX. 16 | ⊚ | ◯ | ⊚ |
| EX. 17 | ◯ | ◯ | ◯ |
| EX. 18 | ◯ | ◯ | ◯ |
| EX. 19 | ⊚ | ◯ | ⊚ |
| EX. 20 | ⊚ | ◯ | ⊚ |
| COMP. | X | X | X |
| EX. 11 | | | |

As described above, the tools according to the second aspect permit simply and stably standing recording sheets therein to dry them.

≦Tool According to Third Aspect>

[Production of Tools 21 to 24]

A coated board (thickness: about 380 μm) was used to produce Tools 21 to 24. The forms and sizes of respective portions were set as described below.

(Tool 21)

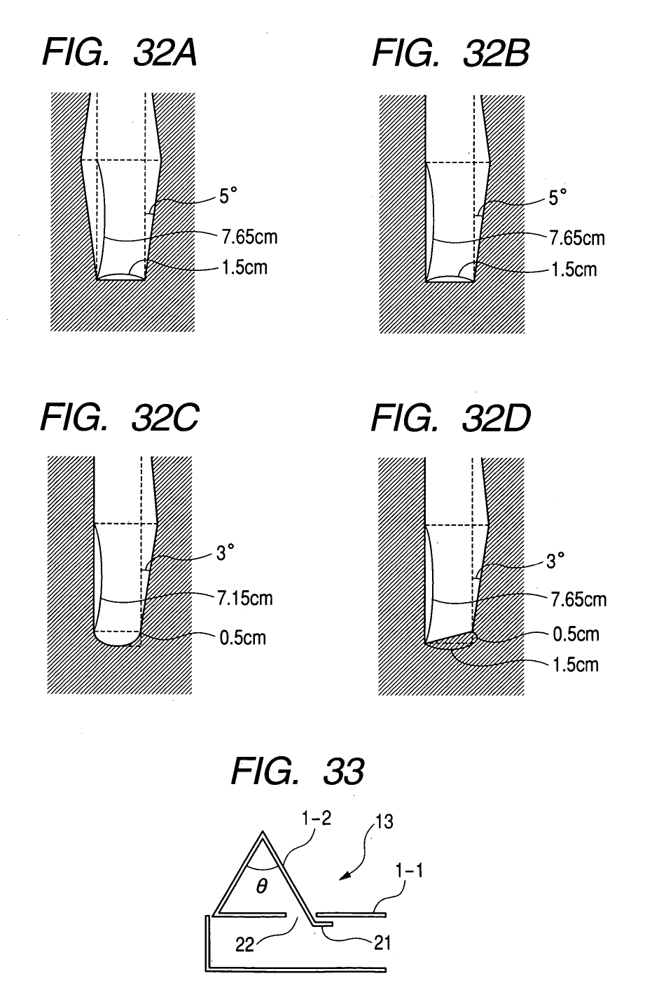

Form: a form illustrated in FIG. 21 (enlarged view of opening: FIG. 32A)

Form of a gable: L=6 cm, H=7 cm.

Opening: 1.5×15.3 cm.

Inclination angle of opening: 5°

Hook: 1.5×2 cm.

Hook hole: 1.6×1.5 cm.

(Tool 22)

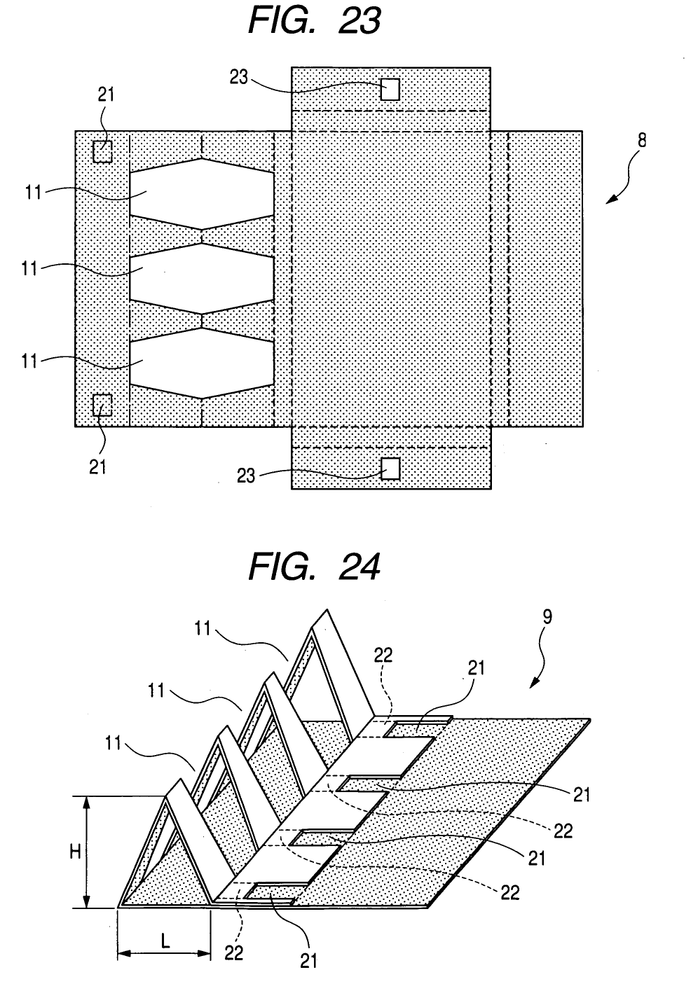

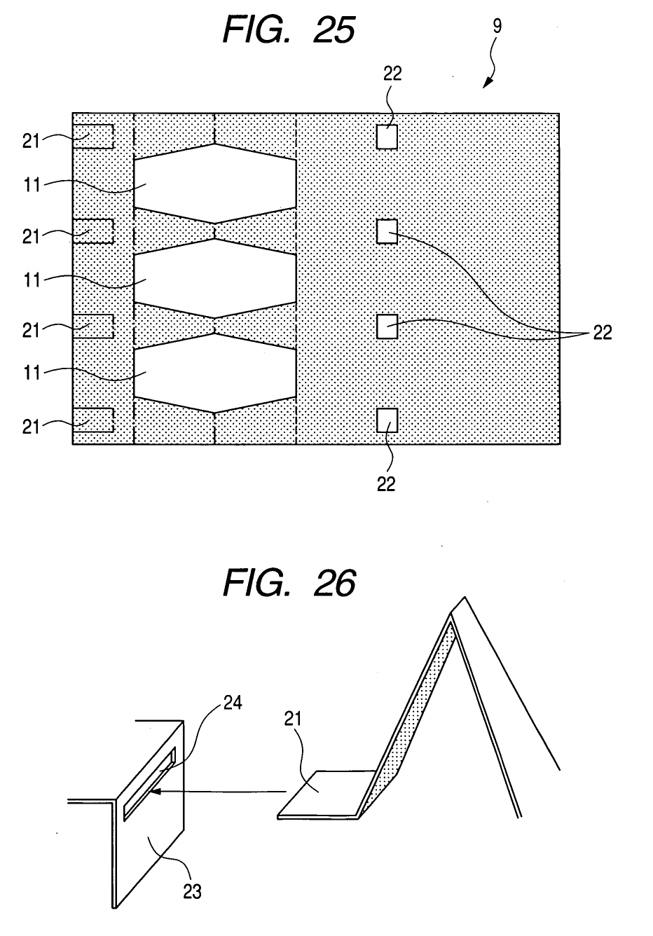

Form: a form illustrated in FIG. 23 (enlarged view of opening: FIG. 32B)

Form of a gable: L=6 cm, H=7 cm.

Opening: 1.5×15.3 cm.

Inclination angle of opening: 5°

Hook: 1.5×2 cm.

Hook hole: 1.6×1.5 cm.

(Tool 23)

Form: a form illustrated in FIG. 23 (however, only hook holes were formed as shown in FIG. 10; enlarged view of opening: FIG. 32C)

Form of a gable: L=6 cm, H=7 cm.

Opening: 1.5×14.3 cm.

Inclination angle of opening: 3°

Hook: 1.5×2 cm.

Hook hole: 1.6×1.5 cm.

(Tool 24)

Form: a form illustrated in FIG. 28 (enlarged view of opening: FIG. 32D)

Form of a gable: L=6 cm, H=7 cm.

Opening: 1.5×15.3 cm (long one) 1.5×14.3 cm (short one)

Inclination angle of opening: 3°

Hook: 1.5×2 cm.

Hook hole: 1.6×1.5 cm.

### EXAMPLEs 21 to 24

In EXAMPLES 21 to 24, Tools 21 to 24 were respectively assembled, and 3 A4-sized ink-jet recording sheets (trade name: SP-101, product of Canon Inc.) were stood in openings in each of the tools to observe a condition thereof. The results are shown in Table 3.

### Comparative Example 21

Such a sheet member as described in Japanese Patent Application Laid-Open No. 2003-276777, which was provided with comb-like supporting pieces formed in at least 2 rows by making a great number of cuts in substantially the same direction, was produced, and 3 ink-jet recording sheets were stood therein to observe a condition thereof. The results are shown in Table 3.

[Evaluation Items]

(Inserting Ability)

The easiness of operation when recording sheets are inserted into the openings in each of the tools was evaluated in accordance with the following standard.

◯: Recording sheets could be easily inserted even when the recording sheets were inserted into the openings from a somewhat oblique direction; and

Δ: Necessary to insert recording sheet into openings from right above.

Stability of tool and Stability of recording sheet were evaluated in accordance with the standards described above.

TABLE 3

| | | | Stability of |
|---|---|---|---|
| | Inserting ability | Stability of tool | recording sheet |
| EX. 21 | ◯ | ◯ | ◯ |
| EX. 22 | ◯ | ◯ | ◯ |
| EX. 23 | ◯ | ⊚ | ◯ |
| EX. 24 | ◯ | ⊚ | ◯ |
| COMP. | Δ | X | X |
| EX. 21 | | | |

As described above, the tools according to the third aspect permit simply and stably standing recording sheets therein to dry them.

≦Package According to Fifth Aspect>

[Production of Tools 31 to 35]

A coated board (thickness: about 380 μm) was used to produce Tools 31 to 35. The forms and sizes of respective portions were set as described below.

(Tool 31)

Form: a form illustrated in FIG. 34 (the form of the package is shown in FIG. 36)

Form of a gable: L=6 cm, H=7 cm.

Opening: 1.5 15.3 cm.

Hook: 1.5×2 cm.

Hook hole: 1.6×1.5 cm.

(Tool 32)

Form: a form illustrated in FIG. 44 (the form of the package is shown in FIG. 42)

Form of a gable: L=6 cm, H=7 cm, M=15 cm.

Opening: 1.5×15.3 cm.

Hook: 25.6×1 cm.

Hook hole: 26×1 cm.

(Tool 33)

Form: a form illustrated in FIG. 40 (the form of the package is shown in FIG. 37)

Form of a gable: L=6 cm, H=7 cm.

Opening: 1.5×15.3 cm.

Hook: 1.5×2 cm.

Hook hole: 1.6×1.5 cm.

(Tool 34)

Form: a form illustrated in FIG. 44 (the form of the package is shown in FIG. 45; however, only hook holes were formed as shown in FIG. 10)

Form of a gable: L=6 cm, H=7 cm, M=15 cm.

Opening: 1.5×15.3 cm.

Hook: 25.6 1 cm.

Hook hole: 26×1 cm.

(Tool 35)

Form: a form illustrated in FIG. 18.

Form of a gable: L=6 cm, H=7 cm.

Opening: 1.5×15.3 cm.

### EXAMPLEs 31 to 35

In EXAMPLES 31 to 35, Tools 31 to 35 were respectively assembled, and 3 A4-sized ink-jet recording sheets (trade name: SP-101, product of Canon Inc.) were stood in openings in each of the tools to observe a condition thereof. The results are shown in Table 4.

### Comparative Example 31

Such a sheet member as described in Japanese Patent Application Laid-Open No. 2003-276777, which was provided with comb-like supporting pieces formed in at least 2 rows by making a great number of cuts in substantially the same direction, was produced, and 3 ink-jet recording sheets were stood therein to observe a condition thereof. The results are shown in Table 4.

[Evaluation Items]

Stability of tool and Stability of recording sheet were evaluated in accordance with the standards described above.

(Durability in Repeated Use)

A process that a tool was assembled, printed recording sheets were dried, and the tool assembled was returned to a box was conducted 30 times repeatedly to observe a condition when the tool was returned to the box, thereby making evaluation in accordance with the following standard.

◯: possible to store the recording sheet as well as possible to be assembled and to dry the recording sheet; and

×: impossible to store the recording sheet or impossible to be assembled and to dry the recording sheet.

TABLE 4

| | | Stability of | Durability in |
|---|---|---|---|
| | Stability of tool | recording sheet | repeated use |
| EX. 31 | ◯ | ◯ | ◯ |
| EX. 32 | ⊚ | ◯ | ◯ |
| EX. 33 | ⊚ | ◯ | ◯ |
| EX. 34 | ⊚ | ◯ | ◯ |
| EX. 35 | ⊚ | ◯ | ⊚ |
| COMP. | X | X | X |
| EX. 31 | | | |

As described above, the tools according to the fifth aspect permit simply and stably standing recording sheets therein to dry them.

This application claims priority from Japanese Patent Applications No. 2004-171239 filed Jun. 9, 2004, No. 2004-171241 filed Jun. 9, 2004, No. 2004-171242 filed Jun. 9, 2004, and No. 2004-171243 filed Jun. 9, 2004, which are hereby incorporated by reference herein.

1. A tool having a divided portion capable of forming an opening capable of holding a recording sheet by being raised in a gable form, which comprises a hook capable of retaining the gable form utilizing a restoring force when formed in the gable form and a hook hole into which the e hook can fit.

2. The tool according to claim 1, which has a gable structure that the restoring force functioning to return to a flat form as to an apex of the gable form formed by folding a flat paper in the gable form is converted to a locking force between the hook and the hook hole.

3. The tool according to claim 1, which comprises a portion that can be cut out to become the opening.

4. A tool comprising a divided portion in which an opening into which a recording sheet can be inserted can be formed by raising a part of a flat sheet in a gable form,
wherein the divided portion forms the gable form with 2 slant faces continuing through a mountain fold line to become an apex line,
the opening is formed by drawing an opening cut portion to become the opening in the flat sheet along a border line to become a side of the slant faces,
the border line has a cut portion passing through the front and back surface of the flat sheet and separating the opening cut portion and a portion surrounding it, which becomes the side of the slant faces in advance, and
at least a portion of the side of the slant faces with which the recording sheet comes into contact is obtained from a portion separated from the opening cut portion in advance by the cut portion.

5. The tool according to claim 4, wherein the border line has a connecting portion that connects the opening cut portion to the portion surrounding the opening cut portion which becomes the side of the slant faces and is to be cut off upon drawing of the opening cut portion, and the connecting portion is provided at a portion to become a dented portion with which a recording sheet comes into no contact in the side of the slant faces to prevent cut marks caused by cutting of the connecting portion from coming into contact with the recording sheet.

6. A tool comprising a divided portion in which an openings into which a recording sheet can be inserted and stood can be formed by raising a part of a flat sheet in a gable form, a hook provided at a foot portion of the divided portion and capable of retaining the gable form utilizing a restoring force when the divided portion has been formed in the gable form, and a hook hole into which the hook can fit and which fixes the position of the hook in the fitted state to retain the gable form,
wherein the divided portion forms the gable form with 2 slant faces continuing through a mountain fold line to become an apex line, and a distance between sides of slant faces of the divided portion opposing through the opening increases from the foot portion of the gable form toward an apex thereof.

7. The tool according to claim 6, wherein a concavely curved portion which guides a position of a lower end of the recording sheet to a predetermined position is provided at the bottom of the opening.

8. The tool according to claim 6, wherein a slant side guiding a position of a lower end of the recording sheet to a predetermined position is provided at the bottom of the opening.

9. The tool according to claim 6, wherein the opening is formed by drawing an opening cut portion to become the opening in the flat sheet along a border line to become a side of the slant faces.

10. The tool according to claim 1, 4 or 6, wherein the recording sheet is an ink-jet recording sheet.

11. The tool according to claim 10, which can be used as a package for packaging the ink-jet recording sheet together with the tool.

12. The tool according to claim 1, 4 or 6, wherein the recording sheet is that subjected to printing.

13. A method for drying a recording sheet, which comprises assembling the tool according to claim 1, 4 or 6 so as to raise the opening with which the tool is equipped in a gable form and standing the recording sheet subjected to printing into the opening, thereby drying the recording sheet subjected to printing.

14. A package with a tool for a recording sheet, which comprises a box capable of containing the recording sheet therein and a tool fixed to at least one external surface of the box for drying a recorded article obtained by conducting recording on the recording sheet,
wherein the tool can form an opening capable of holding the recording sheet by being raised in a gable form, and further comprise a hook capable of retaining the gable form utilizing a restoring force when formed in the gable form and a hook hole into which the hook can fit.

15. The package according to claim 14, wherein the opening is formed by drawing an opening cut portion to become the opening in the flat sheet along a border line to become a side of the slant faces.

16. The package according to claim 14, wherein the recording sheet is an ink-jet recording sheet.

17. The package according to claim 14, wherein the recording sheet is that subjected to printing.
